(19) United States
(12) Patent Application Publication
(10) Pub. No.: US 2025/0356456 A1
(43) Pub. Date: Nov. 20, 2025

(54) SUPER-RESOLUTION USING TIME-SPACE-FREQUENCY TOKENS

(71) Applicant: Microsoft Technology Licensing, LLC, Redmond, WA (US)

(72) Inventors: Huan YANG, Beijing (CN); Jianlong FU, Beijing (CN)

(73) Assignee: Microsoft Technology Licensing, LLC, Redmond, WA (US)

(21) Appl. No.: 18/874,049

(22) PCT Filed: Jun. 17, 2022
(86) PCT No.: PCT/CN2022/099502

§ 371 Date: Dec. 11, 2024

(51) Int. Cl. G06T 3/4053; G06T 3/4007; G06T 3/4046; G06T 7/20

(52) U.S. Cl. CPC G06T 3/4053; G06T 3/4007; G06T 3/4046; G06T 7/20; G06T 2207/10016; G06T 2207/20021; G06T 2207/20052; G06T 2207/20081; G06T 2207/20084

(57) ABSTRACT

A computing device including a processor configured to receive input video data including a plurality of input images. Each of the input images may include a plurality of input pixels. For each input image, the processor may be further configured to perform upsampling on the input image and divide the upsampled input image into a respective plurality of patches. For each patch, the processor may be further configured to generate a plurality of time-space-frequency tokens. The plurality of time-space-frequency tokens generated for the patch may be indexed by timestep, spatial location, and frequency. At least in part at a trained machine learning model, the processor may be further configured to generate a plurality of super-resolved output images based at least in part on the time-space-frequency tokens. The processor may be further configured to output the super-resolved output images.

### BACKGROUND

Video data is frequently stored and transmitted in compressed form. Compressing the video data reduces the amount of data included in the video, which may allow the video to be stored or transmitted more easily. However, when video data is compressed, image quality may be noticeably reduced. Compressing the video data may accordingly result in a degraded user experience and in the loss of image details (e.g., text or facial features) in the video that may be relevant to the user.

Video super-resolution (VSR) is the task of constructing a sequence of high-resolution (HR) frames of video data from a sequence of low-resolution (LR) frames. VSR may therefore be used to restore HR video data from LR video data that is received in compressed form. By using VSR, the reduction in video file size from compression may be achieved while at least partially avoiding degradation of the image quality.

In other examples, VSR may also be used to enhance the image quality of uncompressed video. For example, VSR may be applied to uncompressed video data collected by a low-resolution camera to effectively increase the camera resolution. Using VSR on uncompressed data may therefore allow a smaller, less expensive camera to be used while maintaining the quality of the collected video data.

### SUMMARY

According to one aspect of the present disclosure, a computing device is provided, including a processor configured to receive input video data including a plurality of input images. Each of the plurality of input images may include a plurality of input pixels. For each input image of the plurality of input images, the processor may be further configured to perform upsampling on the input image and divide the upsampled input image into a respective plurality of patches. For each patch of the plurality of patches, the processor may be further configured to generate a plurality of time-space-frequency tokens. The plurality of time-space-frequency tokens generated for the patch may be indexed by timestep, spatial location, and frequency. At least in part at a trained machine learning model, the processor may be further configured to generate a plurality of super-resolved output images based at least in part on the plurality of time-space-frequency tokens. The processor may be further configured to output the plurality of super-resolved output images.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 schematically shows an example computing device at which output video data including a plurality of super-resolved output images is generated from input video data, according to one example embodiment.

FIG. 2 shows an example pre-processing stage that may be performed at a processor included in the computing device, according to the example of FIG. 1.

FIG. 3 schematically shows the generation of a plurality of time-space-frequency tokens at the pre-processing stage, according to the example of FIG. 2.

FIG. 4 schematically shows an example trained machine learning model configured to be executed at the processor, according to the example of FIG. 1.

FIG. 5 schematically shows an example post-processing stage configured to be performed at the processor, according to the example of FIG. 1.

FIG. 6 schematically shows the computing device during training of the trained machine learning model, according to the example of FIG. 1.

FIG. 7A shows a flowchart of an example method for use with a computing device to generate a plurality of super-resolved output images, according to the example of FIG. 1.

FIGS. 7B-7E show additional steps of the method of FIG. 7A that may be performed in some examples.

FIG. 8 shows a schematic view of an example computing environment in which the computing device of FIG. 1 may be instantiated.

### DETAILED DESCRIPTION

Existing approaches to VSR are often unable to produce super-resolved video data that accurately matches the ground-truth appearance of scenes depicted in the input video data. For example, existing VSR methods frequently do not distinguish between compression artifacts and physical textures in an imaged scene. Thus, such VSR methods may be unable to achieve desired improvements in image quality.

In order to address the above shortcomings of existing VSR methods, the devices and methods discussed below are provided. The devices and methods discussed below make use of a tokenization scheme in which frequency data, as well as spatial and temporal data, is encoded in tokens that are used as inputs to a trained machine learning model. The trained machine learning model may be a transformer network, as discussed in further detail below. “Frequency” as used herein refers to a spatial frequency with which a repeated texture occurs in an input image.

The devices and methods discussed below may also use a recurrent structure via which information on optical flow between frames of the input video data may be propagated to the frames of the output video data. The information on the optical flow may be expressed in a hidden state of the trained machine learning model. The recurrent structure may allow the trained machine learning model to utilize the optical flow data when generating high-resolution images from low-resolution images, with the optical flow data allowing the trained machine learning model to more accurately predict the pixels of the high-resolution image from the low-resolution image data.

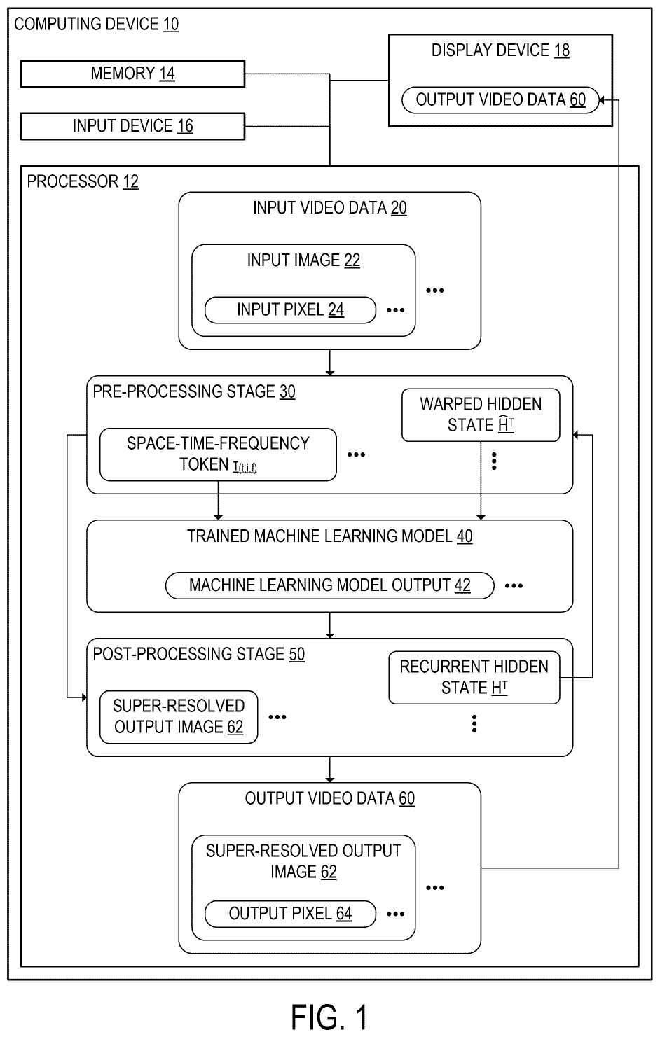

FIG. 1 schematically shows an example computing device 10, according to one embodiment. The computing device 10 may include a processor 12 configured to execute instructions to perform computing processes. For example, the processor 12 may include one or more central processing units (CPUs), graphical processing units (GPUs), field-programmable gate arrays (FPGAs), specialized hardware accelerators, and/or other types of processing devices. The computing device 10 may further include memory 14 that is communicatively coupled to the processor 12. The memory 14 may, for example, include one or more volatile memory devices and/or one or more non-volatile memory devices.

Other components, such as user input devices 16 and/or user output devices, may also be included in the computing device 10. The one or more input devices 16 may, for example, include a keyboard, a mouse, a touchscreen, a microphone, an accelerometer, an optical sensor, and/or other types of input devices. The one or more output devices may include a display device 18 at which output video data 60 generated at the processor 12 may be displayed, as discussed in further detail below. One or more other types of output devices, such as a speaker, may additionally or alternatively be included in the computing device 10.

The computing device 10 may be instantiated in a single physical computing device or in a plurality of communicatively coupled physical computing devices. For example, the computing device 10 may include a physical or virtual server computing device located at a data center. In examples in which the computing device 10 is a virtual server computing device, the functionality of the processor 12 and/or the memory 14 may be distributed between a plurality of physical computing devices. The computing device 10 may, in some examples, be instantiated at least in part at one or more client computing devices. The one or more client computing devices may, in such examples, be configured to communicate with the one or more server computing devices over a network. For example, a client computing device may be configured to offload processing of input video data to a server computing device at which the trained machine learning model is executed. The client computing device may be further configured to receive the output video data from the server computing device.

The processor 12, as shown in the example of FIG. 1, may be configured to receive input video data 20 including a plurality of input images 22. Each of the plurality of input images 22 may include a plurality of input pixels 24. The plurality of input images 22 may be indicated as

$${I}_{L R} = \{ {I}_{LR}^{1} , {I}_{L R}^{2} , … , {I}_{L R}^{T} \} ,$$

where the input images 22 each have height H and width W. The plurality of input images 22 is a sequence of T images. In some examples, the input images 22 may be compressed images generated from ground-truth video data. The ground-truth video data may be high-resolution video data indicated as

$${I}_{H R} = \{ {I}_{HR}^{1} , {I}_{H R}^{2} , … , {I}_{H R}^{T} \} .$$

The processor 12 may be configured to generate output video data 60 that includes a plurality of super-resolved output images 62. Each of the plurality of super-resolved output images 62 may include a plurality of output pixels 64. The plurality of super-resolved output images 62 may be indicated as

$${I}_{S R} = \{ {I}_{SR}^{1} , {I}_{S R}^{2} , … , {I}_{S R}^{T} \} .$$

Each of the super-resolved output images 62 may have a height αH and a width αW, where a represents an upsampling scale factor. The upsampling performed on the input images 22 is discussed in further detail below.

The processor 12 may be further configured to pre-process the plurality of input images 22 at a pre-processing stage 30. At the pre-processing stage 30, the processor 12 may be configured to generate inputs to the trained machine learning model 40. The inputs generated at the pre-processing stage 30 may include a plurality of time-space-frequency tokens τ_{(t,i,f)}. The plurality of time-space-frequency tokens τ_{(t,i,f)} may be indexed by timestep, spatial location, and frequency. In addition, at the pre-processing stage 30, the processor 12 may be further configured to compute a respective warped hidden state Ĥ^{T} for each of the plurality of input images 22 other than a first input image. The warped hidden states Ĥ^{T} may encode optical flow data over a plurality of input images 22.

The processor 12 may be further configured to execute a trained machine learning model 40. In some examples, the trained machine learning model 40 may be a transformer network. In such examples, the plurality of time-space-frequency tokens τ_{(t,i,f)} received at the trained machine learning model 40 may include a plurality of query tokens, a plurality of key tokens, and a plurality of value tokens. In addition, as discussed in further detail below, the plurality of query tokens, the plurality of key tokens, and the plurality of value tokens may include a subset of tokens generated based at least in part on the plurality of warped hidden states Ĥ^{T}. The trained machine learning model 40 may be configured to perform inferencing on the plurality of query tokens, the plurality of key tokens, and the plurality of value tokens at one or more attention heads. Accordingly, the trained machine learning model 40 may be configured to generate a machine learning model output 42. The machine learning model output 42 may be an output of an attention head of the one or more attention heads.

The processor 12 may be further configured to post-process the machine learning model output 42 at a post-processing stage 50. At the post-processing stage 50, the processor 12 may be configured to generate the plurality of super-resolved output images 62 based at least in part on the machine learning model output 42 of the trained machine learning model 40. In addition, the processor 12 may be further configured to generate a recurrent hidden state Ĥ^{T} at the post-processing stage 50. The recurrent hidden state Ĥ^{T} may be used to generate the respective warped hidden states Ĥ^{T} used when processing one or more subsequent input images 22.

Accordingly, at the pre-processing stage 30, the trained machine learning model 40, and the post-processing stage 50, the processor 12 may be configured to generate the output video data 60 from the input video data 20. The processor 12 may be further configured to output the plurality of super-resolved output images 62 included in the output video data 60 for display at the display device 18.

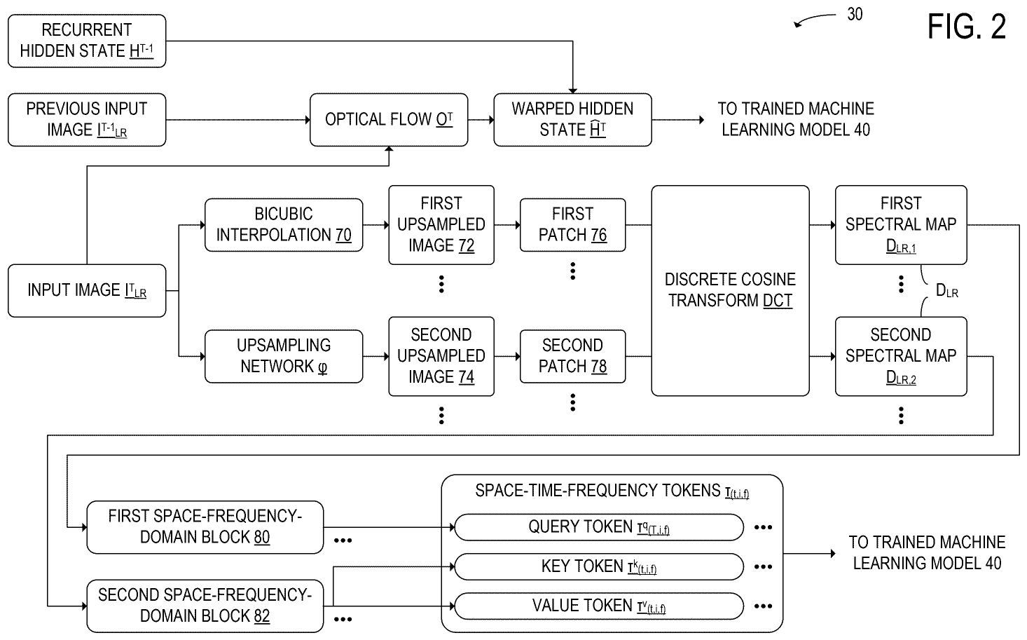

FIG. 2 schematically shows the pre-processing stage 30 in additional detail when an input image 22 is pre-processed. The pre-processing stage 30 may be performed for each input image 22 of the plurality of input images 22. At the pre-processing stage 30, the processor 12 may be configured to perform upsampling on the input image 22. Performing upsampling on the input image 22 may multiply both the height and width of the input image by an upsampling scale factor α, where α>1. Thus, when the super-resolved output images 62 are generated from the input images 22, the resolution of the super-resolved output images 62 may be greater than that of the input images 22.

In some examples, the processor 12 may be configured to perform the upsampling on the input image 22 at least in part by performing bicubic interpolation 70 on the input image 22 to generate a first upsampled image 72. In addition, performing the upsampling may further include processing the input image 22 at an upsampling neural network φ to generate a second upsampled image 74. For example, the upsampling neural network φ may be a super-resolution convolutional neural network (SRCNN) or a BasicVSR network. The bicubic interpolation 70 and the upsampling neural network φ may both be configured to scale the height and width of the input image 22 by the same upsampling scale factor α. Thus, the first upsampled image 72 and the second upsampled image 74 may both have the height αH and the width αW. Generating two different upsampled images from the input image 22 may allow the processor 12 to attend to differences between the first upsampled image 72 and the second upsampled image 74 at the trained machine learning model 40. Attending to the differences between the first upsampled image 72 and the second upsampled image 74 may allow the trained machine learning model 40 to more accurately super-resolve features of the upsampled images that have higher levels of detail.

At the pre-processing stage 30, the processor 12 may be further configured to divide each of the upsampled input images into a respective plurality of patches. Thus, the processor 12 may be configured to generate a plurality of first patches 76 from the first upsampled image 72 and a plurality of second patches 78 from the second upsampled image 74. Each of the first patches 76 and the second patches 78 may have a height of B input pixels 24 and a width of B input pixels 24.

During the pre-processing stage 30, the processor 12 may be further configured to generate a plurality of spectral maps D_{LR} of the plurality of patches. The spectral maps D_{LR} may encode the respective frequencies of component textures included in the input image 22 as a function of spatial location on the horizontal and vertical axes on the input image 22. In examples in which the processor 12 is configured to generate a plurality of first patches 76 and a plurality of second patches 78, the processor 12 may be configured to generate a first spectral map D_{LR,1} and a second spectral map D_{LR,2} for the plurality of first patches 76 and the plurality of second patches 78, respectively.

The spectral maps D_{LR} may each be generated by performing a discrete cosine transform (DCT) on the corresponding patches. The DCT may be configured to perform a projection operation of an image onto a set of cosine components that correspond to two-dimensional frequencies. The spectral maps D_{LR,1} generated using the upsampling neural network φ may accordingly be expressed as:

$${D}_{LR , 1} ( u , v ) = DCT ( φ ( {I}_{LR} ) )$$

The spectral maps D_{LR,2} generated using the bicubic interpolation 70 may similarly be generated via the DCT. In the above equation, u ∈ [0, B-1] and v ∈ [0, B−1] are spatial indexes of the two-dimensional frequencies within a patch. For a patch P with dimensions B×B, the DCT function may be given as follows:

$$DCT ( u , v ) = c ( u ) c ( v ) {\sum }_{x = 0}^{B - 1} {\sum }_{y = 0}^{B - 1} P ( x , y ) cos [ \frac{( 2 x + 1 ) u π}{2 B} ] cos [ \frac{( 2 y + 1 ) v π}{2 B} ]$$

In the above equation, x and y are two-dimensional indices of pixels. c(·) is a normalizing scale factor that enforces orthonormality, with:

$$c ( u ) = \{ \begin{matrix}\sqrt{\frac{1}{B}} , & u = 0 \\ \sqrt{\frac{2}{B}} , & u \neq 0\end{matrix}$$

The spectral map of the patch P generated with the above equation for the DCT may also have dimensions B×B.

The processor 12 may be configured to perform the DCT on each first patch 76 of the plurality of first patches 76 to generate the plurality of first spectral maps D_{LR,1} and perform the DCT on each second patch 78 of the plurality of second patches 78 to generate the plurality of second spectral maps D_{LR,2}. The sequence of first spectral maps D_{LR,1} and the sequence of second spectral maps D_{LR,2} generated from the input video data 20 may each have dimensions

$$T \times F \times C \times \frac{α H}{B} \times \frac{α W}{B} ,$$

where F is the number of dimensions of frequency space, C is a number of frequency bands, αH/B is the height of the spectral map, and αW/B is the width of the spectral map. The number of frequency dimensions F may be given by F=B².

The processor 12 may be further configured to divide each of the spectral maps D_{LR} into a respective plurality of space-frequency-domain blocks during the pre-processing stage 30. The plurality of space-frequency-domain blocks may include a plurality of first space-frequency domain blocks 80 generated from the first spectral maps D_{LR,1} and a plurality of second space-frequency domain blocks 82 generated from the second spectral maps D_{LR,2}. The first space-frequency-domain blocks 80 and the second space-frequency-domain blocks 82 may each have a kernel size of K×K for their respective spatial dimensions.

The processor 12 may be further configured to generate a plurality of time-space-frequency tokens τ_{(t,i,f)} for each patch of the plurality of patches 76 and 78 by dividing each of the space-frequency-domain blocks 80 and 82 into the plurality of time-space-frequency tokens τ_{(t,i,f)}. The processor 12 may be configured to divide the space-frequency-domain blocks 80 and 82 into the time-space-frequency tokens τ_{(t,i,f)} according to spatial location within the patches 76 and 78. The plurality of time-space-frequency tokens τ_{(t,i,f)} may be indexed by timestep, spatial location, and frequency. Thus, the set of time-space-frequency tokens τ_{(t,i,f)} generated for the plurality of input images 22 may be given by:

$$T = \{ {τ}_{( t , i , f )} , t ∈ [ 1 , T ] , i ∈ [ 1 , N ] , f ∈ [ 1 , F ] \}$$

In the above equation, N is the number of blocks generated for each of the spectral maps D_{LR}, and i is an index over the N blocks. Thus, i is an index of the spatial locations of the tokens. Each of the time-space-frequency tokens τ_{(t,i,f)} may have dimensions 1×1×C×K×K. The processor 12 may be configured to generate F time-space-frequency tokens τ_{(t,i,f)} for each block. The total number of total number of time-space-frequency tokens τ_{(t,i,f)} may be given by 2×T×F×N, where the 2 results from using two different upsampling techniques.

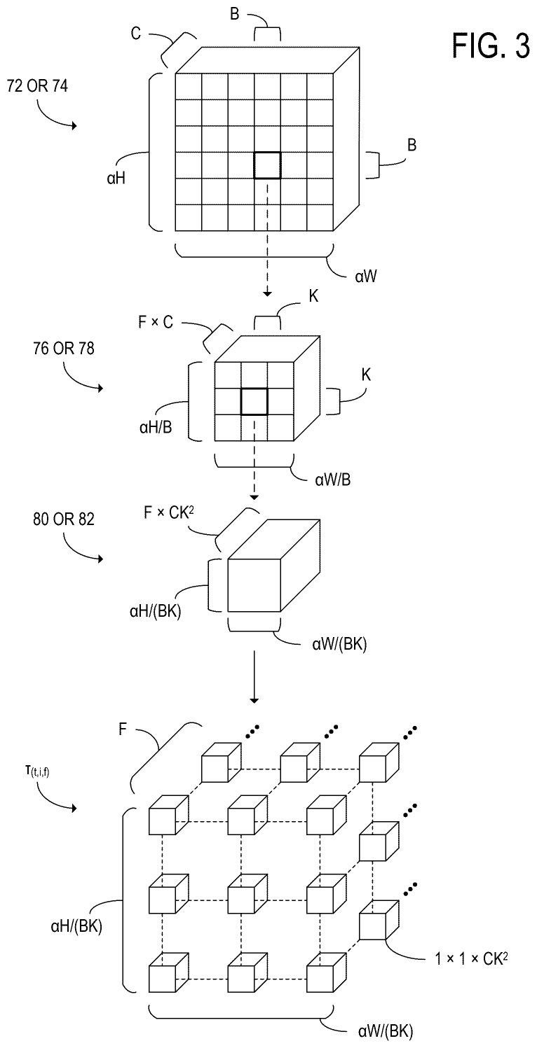

FIG. 3 depicts the tokenization of a first upsampled image 72 or a second upsampled image 74, according to the example of FIG. 2. As shown in FIG. 3, the first upsampled image 72 or second upsampled image 74 may be divided into a plurality of first patches 76 or second patches 78. Each of the first patches 76 or second patches 78 may be subsequently divided into respective sets of first space-frequency-domain blocks 80 or second space-frequency-domain blocks 82. Those blocks may then be further divided into sets of time-space-frequency tokens τ_{(t,i,f)}. In the example of FIG. 3, the respective dimensions of an upsampled image, a patch, a block, and a time-space-frequency token are also shown.

Returning to the example pre-processing stage 30 shown in FIG. 2, the plurality of time-space-frequency tokens τ_{(t,i,f)} may include a plurality of query tokens

$${τ}_{( T , i , f )}^{q} ,$$

a plurality of key tokens

$${τ}_{( t , i , f )}^{k} ,$$

and a plurality of value tokens

$${τ}_{( t , i , f )}^{v} .$$

In order to account for temporal information encoded across the plurality of input images 22, the set of query tokens Q may be extracted from the first spectral map

$${D}_{LR , 1}^{T}$$

generated for the Tth input image 22. The set of key tokens K and the set of value tokens V may be extracted from the second spectral maps

$${D}_{L R , 2}^{t}$$

for t ∈ [1, T−1]. The sets of query, key, and value tokens generated for the input image

$${I}_{L R}^{T}$$

may accordingly be given by:

$$Q = \{ {τ}_{( T , i , f )}^{q} , i ∈ [ 1 , N ] , f ∈ [ 1 , F ] \}$$

$$K = \{ {τ}_{( t , i , f )}^{k} , t ∈ [ 1 , T - 1 ] , i ∈ [ 1 , N ] , f ∈ [ 1 , F ] \}$$

$$V = \{ {τ}_{( t , i , f )}^{v} , t ∈ [ 1 , T - 1 ] , i ∈ [ 1 , N ] , f ∈ [ 1 , F ] \}$$

The time-space-frequency tokens τ_{(t,i,f)} may be extracted from the spectral maps D_{LR} along time, space, and frequency dimensions, and may be generated for each of the input images 22. As discussed in further detail below, the key tokens

$${τ}_{( t , i , f )}^{k}$$

and value tokens

$${τ}_{( t , i , f )}^{v}$$

shown in FIG. 2 may respectively be a plurality of first key tokens and a plurality of first value tokens that are configured to be used as inputs to a first attention head of the trained machine learning model 40.

The example pre-processing stage 30 of FIG. 2 further shows a previous input image

$${I}_{LR}^{T - 1}$$

and a recurrent hidden state H^{T-1}. The previous input image

$${I}_{LR}^{T - 1}$$

may be the input image 22 immediately prior to the input image

$${I}_{LR}^{T}$$

for which generation of the plurality of time-space-frequency tokens τ_{(t,i,f)} is shown in FIG. 2. The recurrent hidden state H^{T-1} may be carried over into the processing of the current input image T from the processing of the previous input image T−1.

At the pre-processing stage 30, the processor 12 may be further configured to compute a plurality of optical flow maps O^{T} between successive pairs of input images 22 included in the input video data 20. FIG. 2 shows the computation of the optical flow map O^{T} between the input image

$${I}_{LR}^{T}$$

and the previous input image

$${I}_{LR}^{T - 1}$$

The optical flow map O^{T} may be a vector field in which a respective plurality of optical flow vectors are associated with locations in the input image

$${I}_{LR}^{T} .$$

For each of the plurality of input images 22 other than a first input image 22, the processor 12 may be further configured to compute a respective warped hidden state Ĥ^{T}. The processor 12 may be configured to compute the warped hidden state Ĥ^{T} at least in part by applying the optical flow map O^{T} to the respective recurrent hidden state H^{T-1} generated for the previous input image 22 of the plurality of input images 22. Applying the optical flow map O^{T} to the recurrent hidden state H^{T-1} may include deforming features included in the recurrent hidden state H^{T-1} by the magnitudes and directions of the vectors indicated in the optical flow map O^{T}.

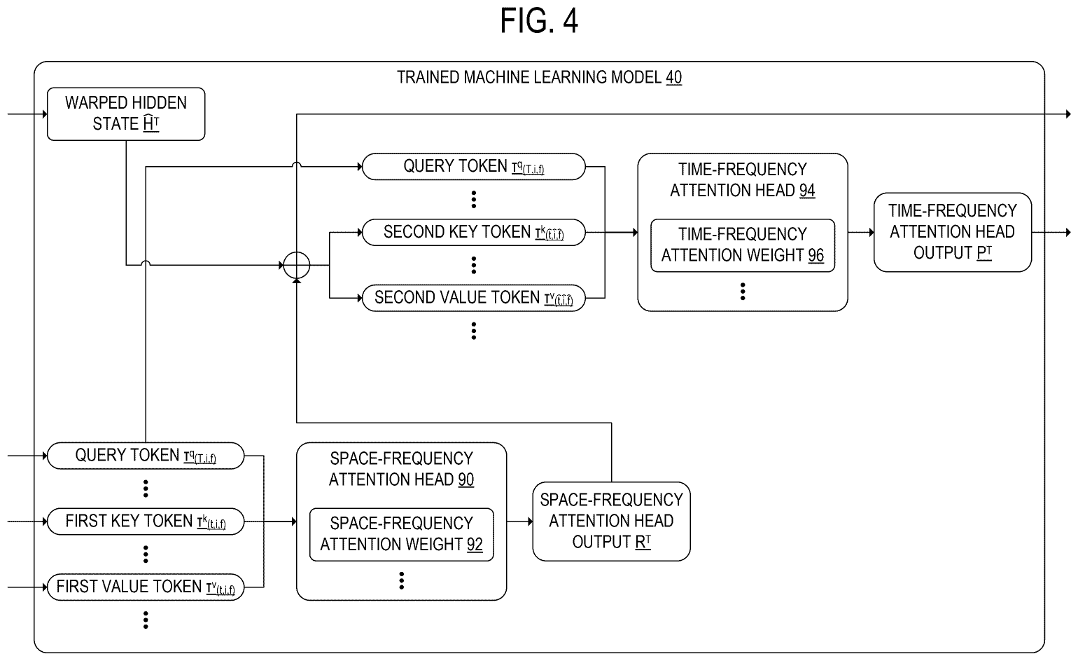

FIG. 4 shows the trained machine learning model 40 according to one example. The trained machine learning model 40 is a transformer network in the example of FIG. 4. As shown in the example of FIG. 4, the trained machine learning model may be configured to receive the plurality of query tokens

$${τ}_{( t , i , f )}^{q} ,$$

the plurality of first key tokens

$${τ}_{( t , i , f )}^{k} ,$$

and the plurality of first value tokens

$${τ}_{( t , i , f )}^{v}$$

as input. In addition, the trained machine learning model 40 may be configured to receive the warped hidden state Ĥ^{T}.

The trained machine learning model 40 may include a space-frequency attention head 90. The space-frequency attention head 90 may be configured to receive the plurality of query tokens

$${τ}_{( T , i , f )}^{q} ,$$

the plurality of first key tokens

$${τ}_{( t , i , f )}^{k} ,$$

and the plurality of first value tokens

$${τ}_{( t , i , f )}^{v} .$$

The query tokens

$${τ}_{( T , i , f )}^{q}$$

used as input at the space-frequency attention head 90 may be query tokens for the current timestep T in the sequence of input images 22.

At the space-frequency attention head 90, the processor 12 may be configured to compute a plurality of space-frequency attention weights 92 between respective space-frequency-domain blocks generated for an input image 22 of the plurality of input images 22. Thus, the space-frequency attention weights 92 may indicate the extent to which the space-frequency attention head 90 attends to different regions of an input space parametrized according to spatial location and frequency. The space-frequency attention head 90 may be configured to compute a space-frequency attention head output R^{T}.

The trained machine learning model 40 may further include a time-frequency attention head 94. The time-frequency attention head 94 may be configured to receive the plurality of query tokens

$${τ}_{( t , i , f )}^{q} ,$$

a plurality of second key tokens

$${τ}_{( \hat{t} , \hat{i} , \hat{f} )}^{k} ,$$

and a plurality of second value tokens

$${τ}_{( \hat{t} , \hat{i} , \hat{f} )}^{v}$$

as input. The query tokens

$${τ}_{( t , i , f )}^{q}$$

used as input at the time-frequency attention head 94 may be query tokens generated for earlier timesteps t ∈ [1, T−1] in the sequence of input images 22. The processor 12 may be configured to generate the plurality of second key tokens

$${τ}_{( \hat{t} , \hat{i} , \hat{f} )}^{k}$$

and the plurality of second value tokens

$${τ}_{( \hat{t} , \hat{i} , \hat{f} )}^{v}$$

at least in part by adding the warped hidden state Ĥ^{T} to the space-frequency attention head output R^{T}.

At the time-frequency attention head, the processor 12 may be configured to compute a plurality of time-frequency attention weights 96 between respective space-frequency-domain blocks generated for a shared spatial location in successive input images 22 of the plurality of input images 22. Thus, the time-frequency attention weights 96 may indicate the extent to which the time-frequency attention head 94 attends to frequency features occurring across a plurality of timesteps in the sequence of input images 22. The time-frequency attention head 94 may be configured to generate a time-frequency attention head output P^{T} that may be transmitted to the post-processing stage 50.

When space-frequency attention and time-frequency attention are composed as shown in FIG. 4, the time-frequency attention head output P^{T} may be a joint time-space-frequency attention output that may be expressed as follows:

$${Λ}_{T \times S} ( {τ}_{( t , i , f )}^{q} , {τ}_{( \hat{t} , \hat{i} , \hat{f} )}^{k} , {τ}_{( \hat{t} , \hat{i} , \hat{f} )}^{v} ) , t ∈ [ 1 , T - 1 ] , \hat{i} ∈ [ 1 , N ] , \hat{f} ∈ [ 1 , N ]$$

The time-space-frequency attention may be computed according to the following equation:

$${Λ}_{T \times S} ( {τ}_{( t , i , f )}^{q} , {τ}_{( \hat{t} , \hat{i} , \hat{f} )}^{k} , {τ}_{( \hat{t} , \hat{i} , \hat{f} )}^{v} ) = SM ( \frac{{τ}_{( t , i , f )}^{q} , {τ}_{( \hat{t} , \hat{i} , \hat{f} )}^{k}}{\sqrt{{d}^{k}}} ) {τ}_{( \hat{t} , \hat{i} , \hat{f} )}^{v}$$

In the above equation, d^{k} is the dimension of each of the key vectors and SM is the softmax function.

At least in part at the trained machine learning model 40, the processor 12 may be further configured to generate the plurality of super-resolved output images 62 based at least in part on the plurality of space-frequency attention weights 92 and the plurality of time-frequency attention weights 96. Although the time-frequency attention head 94 is downstream of the space-frequency attention head 90 in the example of FIG. 4, the order of the time-frequency attention head 94 and the space-frequency attention head 90 may be reversed in other examples. In such examples, the space-frequency attention head 90 may be configured to receive the time-frequency attention head output P^{T}. Furthermore, in such examples, the space-frequency attention head output R^{T} may be the time-space-frequency attention Λ_{T×S}.

By splitting the computation of the time-space-frequency attention Λ_{T×S} between the space-frequency attention head 90 and the time-frequency attention head 94, as shown in the example of FIG. 4, the dimensionality of the inputs when computing the time-space-frequency attention Λ_{T×S} may be decreased compared to computing the time-space-frequency attention at a single attention head. Thus, dividing the computation of the time-space-frequency attention Λ_{T×S} between the space-frequency attention head 90 and the time-frequency attention head 94 may reduce the amount of computation performed when the time-space-frequency attention Λ_{T×S} is computed. In addition, using a space-frequency attention head 90 and a time-frequency attention head 94 may allow the feature size of the spectral maps D_{LR} to be kept consistent between training and inferencing at the transformer network.

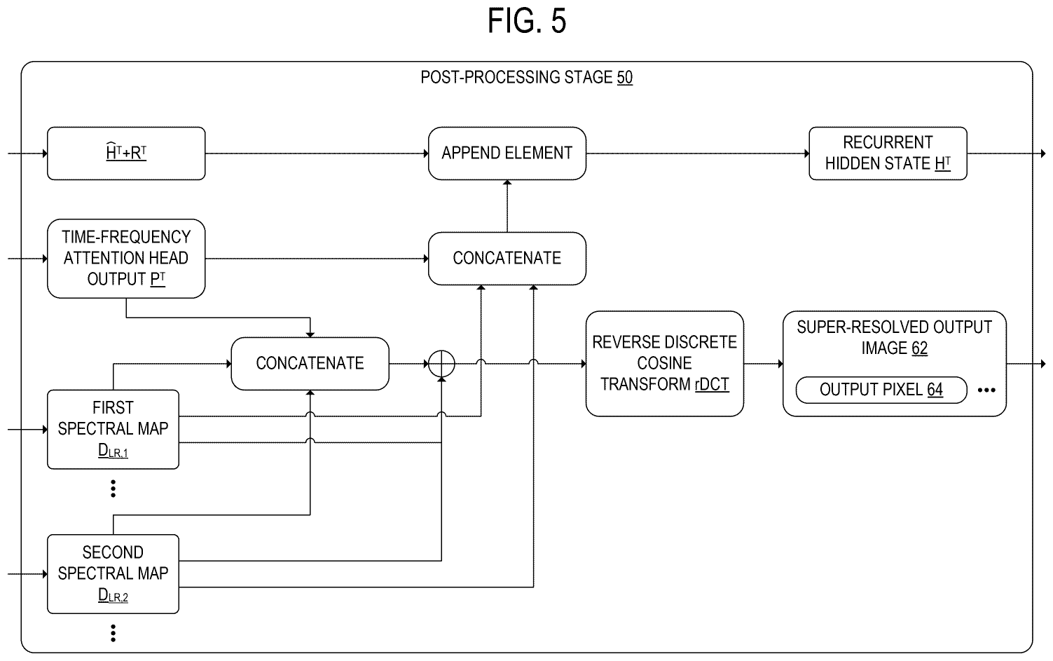

FIG. 5 schematically shows the post-processing stage 50 configured to be performed downstream of the trained machine learning model 40. The post-processing stage 50 is shown when a super-resolved output image 62 included in the output video data 60 is generated. The post-processing stage 50 may be configured to receive the time-frequency attention head output P^{T} from the trained machine learning model 40 depicted in the example of FIG. 4. In examples in which the space-frequency attention head 90 is located downstream of the time-frequency attention head 94, the post-processing stage 50 may instead be configured to receive the space-frequency attention head output R^{T}. In addition, the post-processing stage 50 may be configured to receive the warped hidden state H^{T}. The post-processing stage 50 may be further configured to receive the first spectral maps D_{LR,1} and the second spectral maps D_{LR,2} generated for the input image

$${I}_{L R}^{T} .$$

At the post-processing stage 50, the processor 12 may be configured to concatenate the time-frequency attention head output P^{T} with the plurality of first spectral maps D_{LR,1} and the plurality of second spectral maps D_{LR,2} associated with the corresponding input image

$${I}_{L R}^{T} .$$

The processor 12 may be further configured to add the result of this concatenation to the plurality of first spectral maps D_{LR,1} and the plurality of second spectral maps D_{LR,2}. The processor 12 may be further configured to perform a reverse DCT (rDCT) on the result of the above addition. The output of the rDCT may be the super-resolved output image 62. Thus, at least in part at the trained machine learning model 40 and the post-processing stage 50, the processor 12 may be configured to generate a plurality of super-resolved output images 62 based at least in part on the plurality of time-space-frequency tokens τ_{(t,i,f)} and the warped hidden state Ĥ^{T}.

At the post-processing stage 50, the processor 12 may be further configured to prepare the recurrent hidden state H^{T} for the timestep T such that the recurrent hidden state H^{T} may be used in a subsequent timestep T+1. Preparing the recurrent hidden state H^{T} may include concatenating the time-frequency attention head output P^{T}, the first spectral maps D_{LR,1} generated for the timestep T, and the second spectral maps D_{LR,2} generated for the timestep T. The processor 12 may be further configured to append the result of this concatenation to the sum of the warped hidden state H^{T} and the space-frequency attention head output R^{T} to obtain the recurrent hidden state H^{T}.

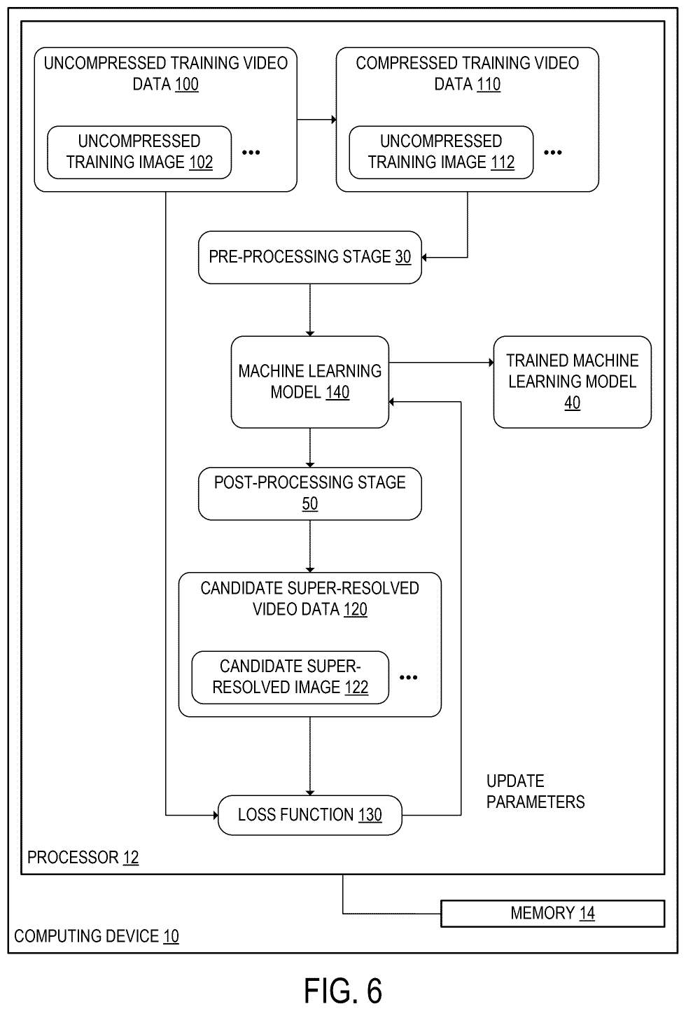

FIG. 6 schematically shows the computing device 10 when a machine learning model 140 is trained at the processor 12 in order to generate the trained machine learning model 40. Although the machine learning model 140 is trained at the computing device 10 in the example of FIG. 6, the machine learning model 140 may be trained at some other computing device and stored in the memory 14 of the computing device 10 in other examples.

As shown in FIG. 6, as a preliminary step to training the machine learning model 140, the processor 12 may be configured to compress uncompressed training video data 100 including a plurality of uncompressed training images 102 in order to generate compressed training video data 110 including a plurality of compressed training images 112. The processor 12 may be configured to use the uncompressed training video data 100 as ground truth when training the machine learning model 140. The uncompressed training video data 100 and the compressed training video data 110 may be organized into a plurality of uncompressed training videos and a corresponding plurality of uncompressed training videos that each include a respective plurality of images. A plurality of different compression rates may be used when the plurality of compressed training videos are generated.

The processor 12 may be further configured to pass the compressed training video data 110 through the pre-processing stage 30, the machine learning model 140, and the post-processing stage 50 to generate candidate super-resolved video data 120. The candidate super-resolved video data 120 may include a plurality of candidate super-resolved images 122.

The processor 12 may be further configured to input the uncompressed training video data 100 and the candidate super-resolved video data 120 into a loss function 130 at which the processor 12 may be configured to compute a loss of the machine learning model 140. For example, the following Charbonnier penalty loss function may be used:

$$L = \frac{1}{T} {\sum }_{t = 1}^{T} \sqrt{{‖ {I}_{H R}^{t} - {I}_{S R}^{t} ‖}^{2} + {ϵ}^{2}}$$

In the above equation, T is the number of frames in an uncompressed training video,

$${I}_{H R}^{t}$$

is the uncompressed training image 102 at the tth frame

$${I}_{S R}^{t}$$

is the candidate super-resolved image 122 at the tth frame, and ϵ is a constant value. For example, ϵ=10⁻³ in some examples. Alternatively, some other value of e may be used. In other examples, some other type of loss function may be used when training the machine learning model 140.

Based at least in part on the value of the loss function 130, the processor 12 may be further configured to update the parameters of the machine learning model 140. For example, the processor 12 may be configured to update the parameters via stochastic gradient descent. The parameters of the machine learning model 140 may be updated in a plurality of training iterations. Thus, the trained machine learning model 40 may be generated by training the machine learning model 140.

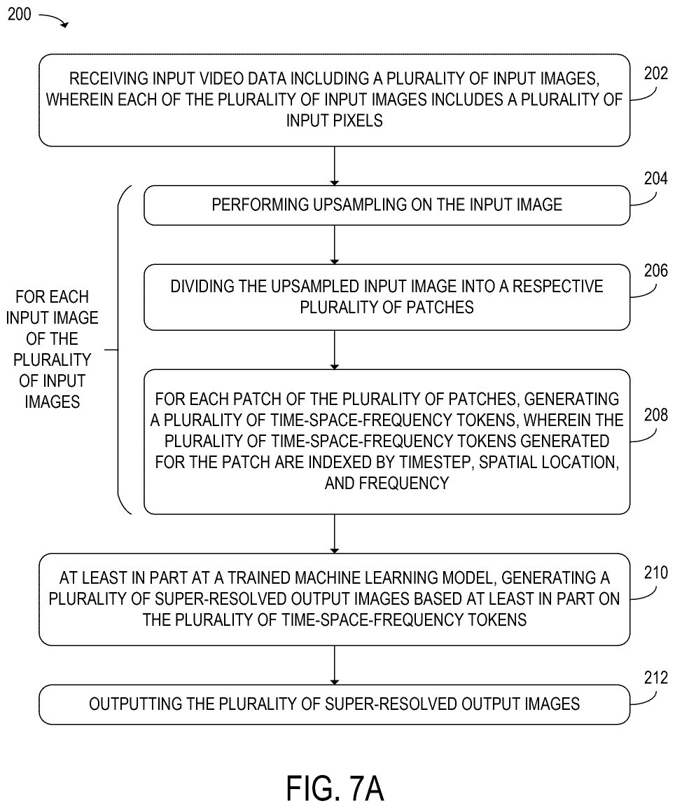

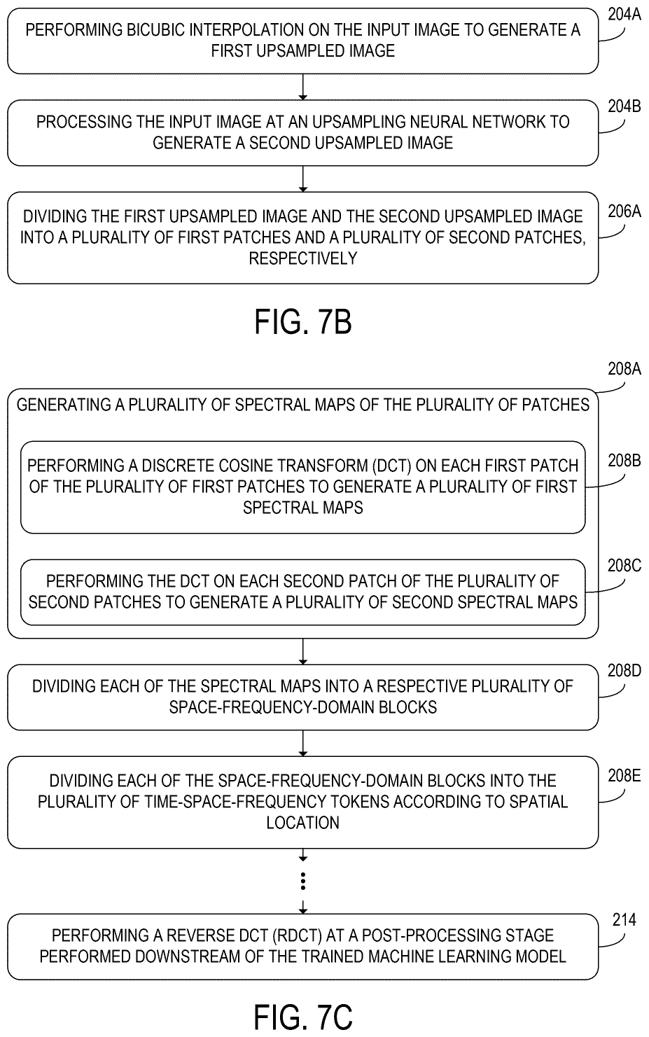

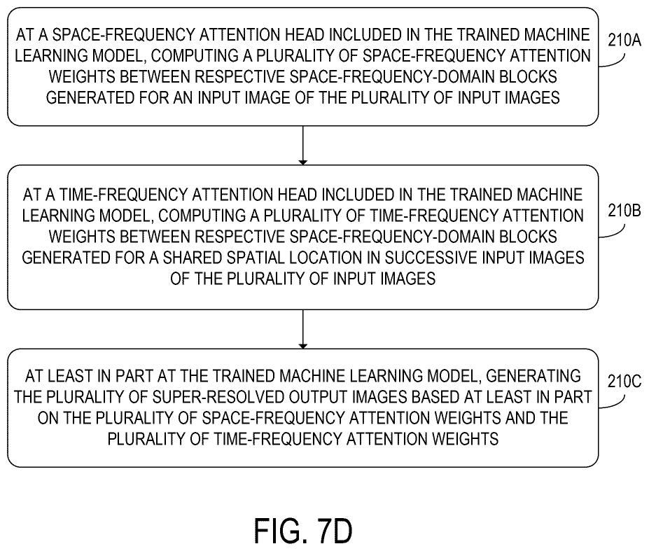

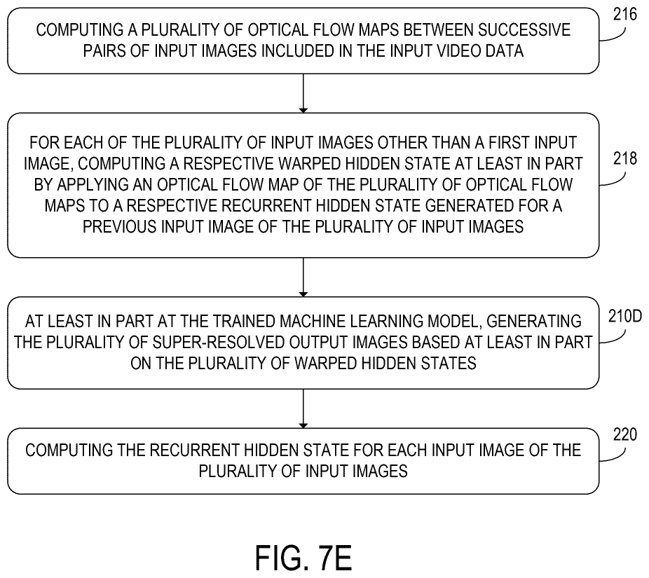

FIG. 7A shows a flowchart of an example method 200 for use with a computing device to generate a plurality of super-resolved output images. At step 202, the method 200 may include receiving input video data including a plurality of input images. Each of the plurality of input images may include a plurality of input pixels.

Steps 204, 206, and 208 of the method 200 may each be performed at a pre-processing stage for each input image of the plurality of input images. At step 204, the method 200 may further include performing upsampling on the input image. When upsampling is performed on an input image, the height and width of the input image may both be increased by an upsampling scale factor. At step 206, the method 200 may further include dividing the upsampled input image into a respective plurality of patches. At step 208, the method 200 may further include generating a plurality of time-space-frequency tokens for each patch of the plurality of patches. The plurality of time-space-frequency tokens generated for the patch may be indexed by timestep, spatial location, and frequency. The frequency according to which the time-space-frequency tokens are indexed is a spatial frequency of repeating texture features within an input image.

At step 210, the method 200 may further include, at least in part at a trained machine learning model, generating a plurality of super-resolved output images based at least in part on the plurality of time-space-frequency tokens. The trained machine learning model may be a transformer network. In addition to the trained machine learning model, the plurality of super-resolved output images may be generated at least in part at a post-processing stage executed subsequently to the trained machine learning model. The post-processing stage may be configured to further process a machine learning model output of the trained machine learning model to generate the plurality of super-resolved output images. For example, the machine learning model output may include a plurality of attention head outputs in examples in which the trained machine learning model is a transformer model.

At step 212, the method 200 may further include outputting the plurality of super-resolved output images. The plurality of super-resolved output images may be output to a display device for display as a super-resolved video. In some examples, the plurality of super-resolved output images may be output to a separate computing device. For example, the plurality of super-resolved output images may be generated at a server computing device and output for display at a client computing device.

FIG. 7B shows additional steps of the method 200 of FIG. 7A that may be performed in some examples. At step 204A, performing the upsampling on the input image at step 204 may include performing bicubic interpolation on the input image to generate a first upsampled image. In addition, at step 204B, performing the upsampling at step 204 may further include processing the input image at an upsampling neural network to generate a second upsampled image.

At step 206A, the generating the plurality of patches at step 206 may further include dividing the first upsampled image and the second upsampled image into a plurality of first patches and a plurality of second patches, respectively. The plurality of first patches and the plurality of second patches may be further processed during the pre-processing stage to generate separate sets of time-space-frequency tokens. Using two different upsampled images when generating the time-space-frequency tokens may allow the trained machine learning model to more accurately reconstruct small-scale textures by attending to differences between the upsampled images.

FIG. 7C shows additional steps of the method 200 that may be performed in some examples. At step 208A, generating the plurality of time-space-frequency tokens at step 208 may include generating a plurality of spectral maps of the plurality of patches. In examples in which two different upsampling techniques are used, as shown in FIG. 7B, step 208A may further include, at step 208B, performing a DCT on each first patch of the plurality of first patches to generate a plurality of first spectral maps. In addition, step 208A may further include, at step 208C, performing the DCT on each second patch of the plurality of second patches to generate a plurality of second spectral maps.

At step 208D, generating the plurality of time-space-frequency tokens may further include dividing each of the spectral maps into a respective plurality of space-frequency-domain blocks. In examples in which two different upsampling techniques are used to generate separate sets of spectral maps, the plurality of first spectral maps and the plurality of second spectral maps may be divided into a first plurality of space-frequency-domain blocks and a second plurality of space-frequency-domain blocks, respectively.

Step 208 may further include, at step 208E, dividing each of the space-frequency-domain blocks into the plurality of time-space-frequency tokens according to spatial location. In examples in which the trained machine learning model is a transformer model, the plurality of time-space-frequency tokens may include a plurality of query tokens generated from the plurality of first space-frequency-domain blocks. The plurality of time-space-frequency tokens may further include a plurality of key tokens and a plurality of value tokens generated from the plurality of second space-frequency-domain blocks.

In examples in which the DCT is performed during the pre-processing stage, as shown at step 208B and step 208C, the method 200 may further include performing a reverse DCT (rDCT) at the post-processing stage downstream of the trained machine learning model. The rDCT may, for example, be performed on an intermediate post-processing result rather than on a direct output of the trained machine learning model. In some examples, the rDCT may be a final post-processing step at which the plurality of super-resolved output images are generated.

FIG. 7D shows additional steps of the method 200 that may be performed in examples in which the trained machine learning model is a transformer network. At step 210A, executing the trained machine learning model at step 210 may include computing a plurality of space-frequency attention weights between respective space-frequency-domain blocks generated for an input image of the plurality of input images. Step 210A may be performed at a space-frequency attention head included in the trained machine learning model. The space-frequency attention head may be configured to receive, as input, a plurality of query tokens, a plurality of first key tokens, and a plurality of first value tokens included among the plurality of time-space-frequency tokens generated at the pre-processing stage. The query tokens used as input to the space-frequency attention head may include the subset of query tokens generated for a current frame of the input video data.

At step 210B, executing the trained machine learning model may further include computing a plurality of time-frequency attention weights between respective space-frequency-domain blocks generated for a shared spatial location in successive input images of the plurality of input images. The time-frequency attention weights may be computed at a time-frequency attention head included in the trained machine learning model. The time-frequency attention head may be configured to receive, as input, the plurality of query tokens, a plurality of second key tokens, and a plurality of second value tokens included among the plurality of time-space-frequency tokens. The query tokens used as input at the time-frequency attention head may include the subset of the query tokens generated for prior frames of the input video data. The plurality of second key tokens and the plurality of second value tokens may be computed based at least in part on an output of the space-frequency attention head. In other examples, the order of the space-frequency attention head and the time-frequency attention head may be reversed.

At step 210C, step 210 may further include generating the plurality of super-resolved output images at least in part at the trained machine learning model based at least in part on the plurality of space-frequency attention weights and the plurality of time-frequency attention weights. As discussed above, post-processing may also be applied to outputs of the trained machine learning model when generating the plurality of super-resolved output images.

FIG. 7E shows additional steps of the method 200 by which a recurrent structure may be implemented. At step 216, the method 200 may further include computing a plurality of optical flow maps between successive pairs of input images included in the input video data. At step 218, the method 200 may further include, for each of the plurality of input images other than a first input image, computing a respective warped hidden state. The warped hidden state may be generated at least in part by applying an optical flow map of the plurality of optical flow maps to a respective recurrent hidden state generated for a previous input image of the plurality of input images. Step 216 and step 218 may be performed during the pre-processing stage.

At step 210D, executing the trained machine learning model at step 210 may further include at least in part at the trained machine learning model, generating the plurality of super-resolved output images based at least in part on the plurality of warped hidden states. In some examples, the plurality of warped hidden states may be used to generate the plurality of second key tokens and the plurality of second value tokens received as input at the time-frequency attention head.

At step 220, the method 200 may further include computing the recurrent hidden state for each input image of the plurality of input images. Computing the recurrent hidden state may, in some examples, include adding a space-frequency attention head output to the warped hidden state. The sum of the space-frequency attention head output may be appended to a concatenation of the time-frequency attention head output, the first spectral map, and the second spectral map to obtain the recurrent hidden state for the current timestep. This recurrent hidden state may be utilized at the trained machine learning model at a subsequent timestep.

Using the devices and methods discussed above, super-resolution may be performed on input video data. VSR performed as discussed above may have higher image quality when super-resolving small-scale features of the input images compared to previous VSR methods. Thus, the devices and methods discussed above may allow for improvements in the viewer experience when applied to either compressed or uncompressed video data.

In some embodiments, the methods and processes described herein may be tied to a computing system of one or more computing devices. In particular, such methods and processes may be implemented as a computer-application program or service, an application-programming interface (API), a library, and/or other computer-program product.

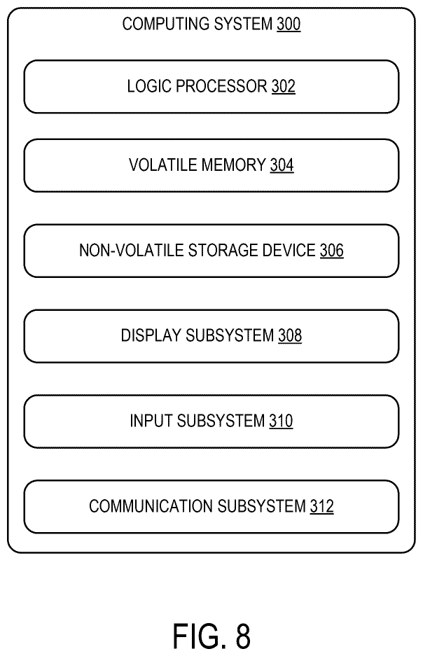

FIG. 8 schematically shows a non-limiting embodiment of a computing system 300 that can enact one or more of the methods and processes described above. Computing system 300 is shown in simplified form. Computing system 300 may embody the computing device 10 described above and illustrated in FIG. 1. Components of the computing system 300 may be instantiated in one or more personal computers, server computers, tablet computers, home-entertainment computers, network computing devices, video game devices, mobile computing devices, mobile communication devices (e.g., smart phone), and/or other computing devices, and wearable computing devices such as smart wristwatches and head mounted augmented reality devices.

Computing system 300 includes a logic processor 302 volatile memory 304, and a non-volatile storage device 306. Computing system 300 may optionally include a display subsystem 308, input subsystem 310, communication subsystem 312, and/or other components not shown in FIG. 3.

Logic processor 302 includes one or more physical devices configured to execute instructions. For example, the logic processor may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors (hardware) configured to execute software instructions. Additionally or alternatively, the logic processor may include one or more hardware logic circuits or firmware devices configured to execute hardware-implemented logic or firmware instructions. Processors of the logic processor 302 may be single-core or multi-core, and the instructions executed thereon may be configured for sequential, parallel, and/or distributed processing. Individual components of the logic processor optionally may be distributed among two or more separate devices, which may be remotely located and/or configured for coordinated processing. Aspects of the logic processor may be virtualized and executed by remotely accessible, networked computing devices configured in a cloud-computing configuration. In such a case, these virtualized aspects are run on different physical logic processors of various different machines, it will be understood.

Non-volatile storage device 306 includes one or more physical devices configured to hold instructions executable by the logic processors to implement the methods and processes described herein. When such methods and processes are implemented, the state of non-volatile storage device 306 may be transformed—e.g., to hold different data.

Non-volatile storage device 306 may include physical devices that are removable and/or built-in. Non-volatile storage device 306 may include optical memory (e.g., CD, DVD, HD-DVD, Blu-Ray Disc, etc.), semiconductor memory (e.g., ROM, EPROM, EEPROM, FLASH memory, etc.), and/or magnetic memory (e.g., hard-disk drive, floppy-disk drive, tape drive, MRAM, etc.), or other mass storage device technology. Non-volatile storage device 306 may include nonvolatile, dynamic, static, read/write, read-only, sequential-access, location-addressable, file-addressable, and/or content-addressable devices. It will be appreciated that non-volatile storage device 306 is configured to hold instructions even when power is cut to the non-volatile storage device 306.

Volatile memory 304 may include physical devices that include random access memory. Volatile memory 304 is typically utilized by logic processor 302 to temporarily store information during processing of software instructions. It will be appreciated that volatile memory 304 typically does not continue to store instructions when power is cut to the volatile memory 304.

Aspects of logic processor 302, volatile memory 304, and non-volatile storage device 306 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 300 typically implemented in software by a processor to perform a particular function using portions of volatile memory, which function involves transformative processing that specially configures the processor to perform the function. Thus, a module, program, or engine may be instantiated via logic processor 302 executing instructions held by non-volatile storage device 306, using portions of volatile memory 304. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 308 may be used to present a visual representation of data held by non-volatile storage device 306. The visual representation may take the form of a graphical user interface (GUI). As the herein described methods and processes change the data held by the non-volatile storage device, and thus transform the state of the non-volatile storage device, the state of display subsystem 308 may likewise be transformed to visually represent changes in the underlying data. Display subsystem 308 may include one or more display devices utilizing virtually any type of technology. Such display devices may be combined with logic processor 302, volatile memory 304, and/or non-volatile storage device 306 in a shared enclosure, or such display devices may be peripheral display devices.

When included, input subsystem 310 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on-or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity; and/or any other suitable sensor.

When included, communication subsystem 312 may be configured to communicatively couple various computing devices described herein with each other, and with other devices. Communication subsystem 312 may include wired and/or wireless communication devices compatible with one or more different communication protocols. As non-limiting examples, the communication subsystem may be configured for communication via a wireless telephone network, or a wired or wireless local-or wide-area network, such as a HDMI over Wi-Fi connection. In some embodiments, the communication subsystem may allow computing system 300 to send and/or receive messages to and/or from other devices via a network such as the Internet.

The following paragraphs discuss several aspects of the present disclosure. According to one aspect of the present disclosure, a computing device is provided, including a processor configured to receive input video data including a plurality of input images. Each of the plurality of input images may include a plurality of input pixels. For each input image of the plurality of input images, the processor may be further configured to perform upsampling on the input image and divide the upsampled input image into a respective plurality of patches. For each patch of the plurality of patches, the processor may be further configured to generate a plurality of time-space-frequency tokens. The plurality of time-space-frequency tokens generated for the patch may be indexed by timestep, spatial location, and frequency. At least in part at a trained machine learning model, the processor may be further configured to generate a plurality of super-resolved output images based at least in part on the plurality of time-space-frequency tokens. The processor may be further configured to output the plurality of super-resolved output images.

According to this aspect, the processor may be further configured to perform the upsampling on the input image at least in part by performing bicubic interpolation on the input image to generate a first upsampled image. Performing the upsampling may further include processing the input image at an upsampling neural network to generate a second upsampled image. The processor may be further configured to divide the first upsampled image and the second upsampled image into a plurality of first patches and a plurality of second patches, respectively.

According to this aspect, the processor is configured to generate the plurality of time-space-frequency tokens at least in part by generating a plurality of spectral maps of the plurality of patches. Generating the plurality of time-space-frequency tokens may further include dividing each of the spectral maps into a respective plurality of space-frequency-domain blocks. Generating the plurality of time-space-frequency tokens may further include dividing each of the space-frequency-domain blocks into the plurality of time-space-frequency tokens according to spatial location.

According to this aspect, the processor may be configured to generate the plurality of spectral maps at least in part by performing a discrete cosine transform (DCT) on each first patch of the plurality of first patches to generate a plurality of first spectral maps. Generating the plurality of spectral maps may further include performing the DCT on each second patch of the plurality of second patches to generate a plurality of second spectral maps.

According to this aspect, the trained machine learning model may be a transformer network.

According to this aspect, the trained machine learning model may include a space-frequency attention head at which the processor may be configured to compute a plurality of space-frequency attention weights between respective space-frequency-domain blocks generated for an input image of the plurality of input images. The trained machine learning model may further include a time-frequency attention head at which the processor may be configured to compute a plurality of time-frequency attention weights between respective space-frequency-domain blocks generated for a shared spatial location in successive input images of the plurality of input images. At least in part at the trained machine learning model, the processor may be further configured to generate the plurality of super-resolved output images based at least in part on the plurality of space-frequency attention weights and the plurality of time-frequency attention weights.

According to this aspect, the space-frequency attention head may be configured to receive, as input, a plurality of query tokens, a plurality of first key tokens, and a plurality of first value tokens included among the plurality of time-space-frequency tokens. The processor may be configured to generate the plurality of query tokens based at least in part on a plurality of first space-frequency domain blocks generated from the first spectral maps. The processor may be further configured to generate the plurality of first key tokens and the plurality of first value tokens based at least in part on a plurality of second space-frequency domain blocks generated from the second spectral maps.

According to this aspect, the time-frequency attention head may be configured to receive, as input, the plurality of query tokens, a plurality of second key tokens, and a plurality of second value tokens included among the plurality of time-space-frequency tokens. The processor may be configured to generate the plurality of second key tokens and the plurality of second value tokens based at least in part on an output of the space-frequency attention head and on one or more recurrent hidden states.

According to this aspect, the processor may be further configured to generate the plurality of super-resolved output images at least in part by performing a reverse DCT (rDCT) at a post-processing stage performed downstream of the trained machine learning model.

According to this aspect, for each input image of the plurality of input images, the processor may be further configured to output a corresponding recurrent hidden state.

According to this aspect, the processor may be further configured to compute a plurality of optical flow maps between successive pairs of input images included in the input video data. For each of the plurality of input images other than a first input image, the processor may be further configured to compute a respective warped hidden state at least in part by applying an optical flow map of the plurality of optical flow maps to the respective recurrent hidden state generated for a previous input image of the plurality of input images. At the trained machine learning model, the processor may be further configured to generate the plurality of super-resolved output images based at least in part on the plurality of warped hidden states.

According to another aspect of the present disclosure, a method for use with a computing device is provided. The method may include receiving input video data including a plurality of input images. Each of the plurality of input images may include a plurality of input pixels. For each input image of the plurality of input images, the method may further include performing upsampling on the input image and dividing the upsampled input image into a respective plurality of patches. For each patch of the plurality of patches, the method may further include generating a plurality of time-space-frequency tokens. The plurality of time-space-frequency tokens generated for the patch may be indexed by timestep, spatial location, and frequency. At least in part at a trained machine learning model, the method may further include generating a plurality of super-resolved output images based at least in part on the plurality of time-space-frequency tokens. The method may further include outputting the plurality of super-resolved output images.

According to this aspect, performing the upsampling on the input image may include performing bicubic interpolation on the input image to generate a first upsampled image and processing the input image at an upsampling neural network to generate a second upsampled image. The method may further include dividing the first upsampled image and the second upsampled image into a plurality of first patches and a plurality of second patches, respectively.

According to this aspect, generating the plurality of time-space-frequency tokens may include generating a plurality of spectral maps of the plurality of patches. Generating the plurality of time-space-frequency tokens may further include dividing each of the spectral maps into a respective plurality of space-frequency-domain blocks. Generating the plurality of time-space-frequency tokens may further include dividing each of the space-frequency-domain blocks into the plurality of time-space-frequency tokens according to spatial location.

According to this aspect, generating the plurality of spectral maps may include performing a discrete cosine transform (DCT) on each first patch of the plurality of first patches to generate a plurality of first spectral maps. Generating the plurality of spectral maps may further include performing the DCT on each second patch of the plurality of second patches to generate a plurality of second spectral maps.

According to this aspect, the trained machine learning model may be a transformer network.

According to this aspect, at a space-frequency attention head included in the trained machine learning model, the method may further include computing a plurality of space-frequency attention weights between respective space-frequency-domain blocks generated for an input image of the plurality of input images. At a time-frequency attention head included in the trained machine learning model, the method may further include computing a plurality of time-frequency attention weights between respective space-frequency-domain blocks generated for a shared spatial location in successive input images of the plurality of input images. At least in part at the trained machine learning model, the method may further include generating the plurality of super-resolved output images based at least in part on the plurality of space-frequency attention weights and the plurality of time-frequency attention weights.

According to this aspect, the method may further include computing a plurality of optical flow maps between successive pairs of input images included in the input video data. For each of the plurality of input images other than a first input image, the method may further include computing a respective warped hidden state at least in part by applying an optical flow map of the plurality of optical flow maps to a respective recurrent hidden state generated for a previous input image of the plurality of input images. At least in part at the trained machine learning model, the method may further include generating the plurality of super-resolved output images based at least in part on the plurality of warped hidden states. The method may further include computing the recurrent hidden state for each input image of the plurality of input images.

According to another aspect of the present disclosure, a computing device is provided, including a processor configured to receive input video data including a plurality of input images. Each of the plurality of input images may include a plurality of input pixels. For each input image of the plurality of input images, the processor may be further configured to perform upsampling on the input image and divide the upsampled input image into a respective plurality of patches. For each patch of the plurality of patches, the processor may be further configured to generate a plurality of time-space-frequency tokens. The plurality of time-space-frequency tokens generated for the patch may be indexed by timestep, spatial location, and frequency. The plurality of time-space-frequency tokens may include a plurality of query tokens, a plurality of first key tokens, and a plurality of first value tokens. The processor may be further configured to compute a plurality of optical flow maps between successive pairs of input images included in the input video data. For each of the plurality of input images other than a first input image, the processor may be further configured to compute a respective warped hidden state at least in part by applying an optical flow map of the plurality of optical flow maps to a recurrent hidden state generated for a previous input image of the plurality of input images. The processor may be further configured to compute a plurality of second key tokens and a plurality of second value tokens based at least in part on the warped hidden state. At least in part at a transformer network, the processor may be further configured to generate a plurality of super-resolved output images based at least in part on the plurality of query tokens, the plurality of first key tokens, the plurality of first value tokens, the plurality of second key tokens, and the plurality of second value tokens respectively generated for the plurality of input images. The processor may be further configured to output the plurality of super-resolved output images.

According to this aspect, the transformer network may include a space-frequency attention head at which the processor may be configured to receive the plurality of query tokens, the plurality of first key tokens, and the plurality of first value tokens. At the space-frequency attention head, the processor may be further configured to generate a space-frequency attention head output. At the transformer network, the processor may be further configured to generate the plurality of second key tokens and the plurality of second value tokens based at least in part on the space-frequency attention head output and the warped hidden state. The transformer network may further include a time-frequency attention head at which the processor may be further configured to receive the plurality of query tokens, the plurality of second key tokens, and the plurality of second value tokens. At the time-frequency attention head, the processor may be further configured to generate a time-frequency attention head output. The processor may be further configured to generate the plurality of super-resolved images based at least in part on the time-frequency attention head outputs respectively generated for the plurality of input images.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computing device comprising:
a processor configured to:
receive input video data including a plurality of input images, wherein each of the plurality of input images includes a plurality of input pixels; and
for each input image of the plurality of input images:
perform upsampling on the input image;
divide the upsampled input image into a respective plurality of patches; and
for each patch of the plurality of patches, generate a plurality of time-space-frequency tokens, wherein the plurality of time-space-frequency tokens generated for the patch are indexed by timestep, spatial location, and frequency;
at least in part at a trained machine learning model, generate a plurality of super-resolved output images based at least in part on the plurality of time-space-frequency tokens; and
output the plurality of super-resolved output images.

2. The computing device of claim 1, wherein the processor is configured to:
perform the upsampling on the input image at least in part by:
performing bicubic interpolation on the input image to generate a first upsampled image; and
processing the input image at an upsampling neural network to generate a second upsampled image; and
divide the first upsampled image and the second upsampled image into a plurality of first patches and a plurality of second patches, respectively.

3. The computing device of claim 2, wherein the processor is configured to generate the plurality of time-space-frequency tokens at least in part by:
generating a plurality of spectral maps of the plurality of patches;
dividing each of the spectral maps into a respective plurality of space-frequency-domain blocks; and
dividing each of the space-frequency-domain blocks into the plurality of time-space-frequency tokens according to spatial location.

4. The computing device of claim 3, wherein the processor is configured to generate the plurality of spectral maps at least in part by:
performing a discrete cosine transform (DCT) on each first patch of the plurality of first patches to generate a plurality of first spectral maps; and
performing the DCT on each second patch of the plurality of second patches to generate a plurality of second spectral maps.

5. The computing device of claim 4, wherein the trained machine learning model is a transformer network.

6. The computing device of claim 5, wherein:
the trained machine learning model includes:
a space-frequency attention head at which the processor is configured to compute a plurality of space-frequency attention weights between respective space-frequency-domain blocks generated for an input image of the plurality of input images; and
a time-frequency attention head at which the processor is configured to compute a plurality of time-frequency attention weights between respective space-frequency-domain blocks generated for a shared spatial location in successive input images of the plurality of input images; and
at least in part at the trained machine learning model, the processor is further configured to generate the plurality of super-resolved output images based at least in part on the plurality of space-frequency attention weights and the plurality of time-frequency attention weights.

7. The computing device of claim 6, wherein:
the space-frequency attention head is configured to receive, as input, a plurality of query tokens, a plurality of first key tokens, and a plurality of first value tokens included among the plurality of time-space-frequency tokens; and
the processor is configured to:
generate the plurality of query tokens based at least in part on a plurality of first space-frequency domain blocks generated from the first spectral maps; and
generate the plurality of first key tokens and the plurality of first value tokens based at least in part on a plurality of second space-frequency domain blocks generated from the second spectral maps.

8. The computing device of claim 7, wherein:
the time-frequency attention head is configured to receive, as input, the plurality of query tokens, a plurality of second key tokens, and a plurality of second value tokens included among the plurality of time-space-frequency tokens; and
the processor is configured to generate the plurality of second key tokens and the plurality of second value tokens based at least in part on an output of the space-frequency attention head and on one or more recurrent hidden states.

9. The computing device of claim 4, wherein the processor is further configured to generate the plurality of super-resolved output images at least in part by performing a reverse DCT (rDCT) at a post-processing stage performed downstream of the trained machine learning model.

10. The computing device of claim 1, wherein, for each input image of the plurality of input images, the processor is further configured to output a corresponding recurrent hidden state.

11. The computing device of claim 10, wherein the processor is further configured to:
compute a plurality of optical flow maps between successive pairs of input images included in the input video data;
for each of the plurality of input images other than a first input image, compute a respective warped hidden state at least in part by applying an optical flow map of the plurality of optical flow maps to the respective recurrent hidden state generated for a previous input image of the plurality of input images; and
at the trained machine learning model, generate the plurality of super-resolved output images based at least in part on the plurality of warped hidden states.

12. A method for use with a computing device, the method comprising:
receiving input video data including a plurality of input images, wherein each of the plurality of input images includes a plurality of input pixels; and
for each input image of the plurality of input images:
performing upsampling on the input image;
dividing the upsampled input image into a respective plurality of patches; and
for each patch of the plurality of patches, generating a plurality of time-space-frequency tokens, wherein the plurality of time-space-frequency tokens generated for the patch are indexed by timestep, spatial location, and frequency;
at least in part at a trained machine learning model, generating a plurality of super-resolved output images based at least in part on the plurality of time-space-frequency tokens; and
outputting the plurality of super-resolved output images.

13. The method of claim 12, wherein:
performing the upsampling on the input image includes:
performing bicubic interpolation on the input image to generate a first upsampled image; and
processing the input image at an upsampling neural network to generate a second upsampled image; and
the method further comprises dividing the first upsampled image and the second upsampled image into a plurality of first patches and a plurality of second patches, respectively.

14-15. (canceled)

16. The method of claim 13, wherein generating the plurality of time-space-frequency tokens includes:
generating a plurality of spectral maps of the plurality of patches;
dividing each of the spectral maps into a respective plurality of space-frequency-domain blocks; and
dividing each of the space-frequency-domain blocks into the plurality of time-space-frequency tokens according to spatial location.

17. The method of claim 16, wherein generating the plurality of spectral maps includes:
performing a discrete cosine transform (DCT) on each first patch of the plurality of first patches to generate a plurality of first spectral maps; and
performing the DCT on each second patch of the plurality of second patches to generate a plurality of second spectral maps.

18. The method of claim 13, wherein the trained machine learning model is a transformer network.

19. The method of claim 18, further comprising:
at a space-frequency attention head included in the trained machine learning model, computing a plurality of space-frequency attention weights between respective space-frequency-domain blocks generated for an input image of the plurality of input images;
at a time-frequency attention head included in the trained machine learning model, computing a plurality of time-frequency attention weights between respective space-frequency-domain blocks generated for a shared spatial location in successive input images of the plurality of input images; and
at least in part at the trained machine learning model, generating the plurality of super-resolved output images based at least in part on the plurality of space-frequency attention weights and the plurality of time-frequency attention weights.

20. The method of claim 12, further comprising:
computing a plurality of optical flow maps between successive pairs of input images included in the input video data;
for each of the plurality of input images other than a first input image, computing a respective warped hidden state at least in part by applying an optical flow map of the plurality of optical flow maps to a respective recurrent hidden state generated for a previous input image of the plurality of input images; and
at least in part at the trained machine learning model, generating the plurality of super-resolved output images based at least in part on the plurality of warped hidden states; and
computing the recurrent hidden state for each input image of the plurality of input images.

21. A computing device comprising:
a processor configured to:
receive input video data including a plurality of input images, wherein each of the plurality of input images includes a plurality of input pixels; and
for each input image of the plurality of input images:
perform upsampling on the input image;
divide the upsampled input image into a respective plurality of patches; and
for each patch of the plurality of patches, generate a plurality of time-space-frequency tokens, wherein:
the plurality of time-space-frequency tokens generated for the patch are indexed by timestep, spatial location, and frequency; and
the plurality of time-space-frequency tokens include a plurality of query tokens, a plurality of first key tokens, and a plurality of first value tokens;
compute a plurality of optical flow maps between successive pairs of input images included in the input video data;
for each of the plurality of input images other than a first input image:
compute a respective warped hidden state at least in part by applying an optical flow map of the plurality of optical flow maps to a recurrent hidden state generated for a previous input image of the plurality of input images; and
compute a plurality of second key tokens and a plurality of second value tokens based at least in part on the warped hidden state;
at least in part at a transformer network, generate a plurality of super-resolved output images based at least in part on the plurality of query tokens, the plurality of first key tokens, the plurality of first value tokens, the plurality of second key tokens, and the plurality of second value tokens respectively generated for the plurality of input images; and
output the plurality of super-resolved output images.

22. The computing device of claim 21, wherein:
the transformer network includes a space-frequency attention head at which the processor is configured to:
receive the plurality of query tokens, the plurality of first key tokens, and the plurality of first value tokens; and
generate a space-frequency attention head output;
at the transformer network, the processor is further configured to generate the plurality of second key tokens and the plurality of second value tokens based at least in part on the space-frequency attention head output and the warped hidden state;
the transformer network includes a time-frequency attention head at which the processor is further configured to:
receive the plurality of query tokens, the plurality of second key tokens, and the plurality of second value tokens; and
generate a time-frequency attention head output; and
the processor is further configured to generate the plurality of super-resolved images based at least in part on the time-frequency attention head outputs respectively generated for the plurality of input images.
